(19) United States
(12) Patent Application Publication
(10) Pub. No.: US 2015/0239396 A1
(43) Pub. Date: Aug. 27, 2015

(54) METHOD AND INFORMATION SYSTEM FOR FILTERING OBJECT INFORMATION

(71) Applicant: Robert Bosch GmbH, Stuttgart (DE)

(72) Inventors: Dijanist Gjikokaj, Weinsberg (DE); Andreas Offenhaeuser, Marbach Am Neckar (DE)

(21) Appl. No.: 14/421,403

(22) PCT Filed: Aug. 1, 2013
(86) PCT No.: PCT/EP2013/066183

§ 371 Date: Feb. 12, 2015

(30) Foreign Application Priority Data
Aug. 31, 2012 (DE) 10 2012 215 465.5

(51) Int. Cl. B60Q 9/00; G06T 11/60

(52) U.S. Cl. CPC B60Q 9/008; G06T 11/60

(57) ABSTRACT

In a method for filtering object information, first and second pieces of object information are read in, the first piece of object information representing at least one object detected and identified by a first sensor and the second piece of object information representing at least two objects detected and identified by a second sensor, the first sensor being based on a first sensor principle and the second sensor being based on a second sensor principle differing from the first sensor principle. At least one of the objects in the second piece of object information is also represented in the first piece of object information, and a filtered piece of object information is output which corresponds to objects represented only in the second piece of object information but not in the second piece of object information.

### BACKGROUND OF THE INVENTION

1. Field of the Invention

The present invention relates to a method for filtering object information, a corresponding information system, and a corresponding computer program product.

2. Description of the Related Art

Poor visibility conditions contribute to road accidents across the world. They are often due to vehicle drivers not correctly assessing the situation and overestimating both their own capabilities and the physical capabilities (such as braking distances) of the vehicle.

Published German patent application document DE 101 31 720 A1 describes a head-up display system for depicting an object in a space external to the vehicle.

### BRIEF SUMMARY OF THE INVENTION

Against this background, the present invention provides a method for filtering object information, furthermore, an information system which uses this method, and finally, a corresponding computer program.

Previous systems (for example, night vision systems) detect objects autonomously and display them to the vehicle driver on a screen. It does not matter whether the driver is also able to detect the object without the assistance system. As a result, an unnecessarily large amount of information (information overload) is conveyed to the driver. Even if visibility is poor, assistance may be provided to a driver of a transportation means, for example, a vehicle, if objects in front of the transportation means are identified and displayed. For this purpose, surroundings of the transportation means may be detected and objects in the surroundings may be identified with the aid of a sensor. The objects may be displayed highlighted for the driver. A transportation means may generally be understood to mean a device which is used for transporting persons or goods, such as a vehicle, a truck, a ship, a rail vehicle, an airplane, or a similar transportation means.

This results in an additional cognitive load on the driver of the transportation means or vehicle, since the real objects and the displayed objects must be identified and handled by the driver. In addition, the acceptance of such assistance systems may decrease if the driver gains the subjective impression that the assistance system has no added value.

In order to avoid such a negative effect, sensors may be used which are able to resolve and identify objects regardless of prevailing visibility conditions. Such sensors often have a long range. The range may, for example, extend at ground level from immediately ahead of the transportation means, in particular the vehicle, to a local horizon. Many objects may be detected within the range. If all objects were to be displayed highlighted, a driver might be overwhelmed by the resulting large number of objects which are displayed and must be interpreted. At the very least, the driver might be distracted from traffic events which are visible to him/her.

The present invention is based on the knowledge that a driver of a transportation means such as a vehicle does not need to have objects displayed highlighted which he/she is able to identify himself/herself. For this purpose, for example, objects which have been detected using a sensor having very high resolution for large distances are compared to objects which are also identifiable via a the area visible to the driver ahead of or next to the transportation means sensor. In this respect, it is necessary to extract only a subset of the objects detected by the two sensors, which are then, for example, displayed to the driver on a display in a subsequent step.

Advantageously, from a total set of the objects detected using a long-range sensor, a partial set of identified objects may be subtracted or excluded which, for example, are identified with the aid of a sensor measuring in the visible spectrum, in order to obtain a reduced set of, for example, objects to be displayed subsequently. This makes it possible to reduce the amount of information about the selected or filtered objects, which increases the clarity when displaying it for the driver and, in addition to increased acceptance by the driver, also provides an advantage with respect to the safety of the transportation means, since an indication of objects may now also be provided to a driver which, for example, do not lie in his/her field of vision.

The present invention provides a method for filtering object information, the method including the following steps:
reading in a first piece of object information which represents at least one object which is detected and identified by a first sensor, the first sensor being based on a first sensor principle;
reading in a second piece of object information which represents at least two objects detected and identified by a second sensor, the second sensor being based on a second sensor principle and at least one of the objects also being represented in the first piece of object information, the first sensor principle differing from the second sensor principle; and
outputting a filtered piece of object information which represents those objects which are represented in the second piece of object information and not in the first piece of object information.

A piece of object information may be understood to mean a combination of different parameters of a plurality of objects. For example, a position, a class, a distance, and/or a coordinate value may be associated with an object. The piece of object information may represent a result of an object identification based on one or multiple images and a processing specification. A sensor principle may be understood to mean a type of detection or reproduction of a physical variable to be measured. For example, a sensor principle may include the use of electromagnetic waves in a predetermined spectral range for detecting the physical variable to be measured. Alternatively, a sensor principle may also include the use of ultrasonic signals for detecting a physical variable to be measured. It should be possible to determine a difference between the first sensor principle and the second sensor principle, which, for example, is characterized by the detection or evaluation of a sensor signal. The detection or evaluation of the physical variables detected by the two sensors should differ as a result. A first sensor may, for example, be a camera. The first sensor may thus, for example, be sensitive to visible light. The first sensor may thus be subject to optical limitations similar to those of a human eye. For example, the first sensor may have a limited field of vision in the case of fog or rain occurring ahead of the vehicle. A second sensor may, for example, be a sensor which detects a significantly longer range. For example, the second sensor may provide a piece of directional information and/or a piece of distance information about an object. For example, the second sensor may be a radar or lidar sensor.

According to one advantageous specific embodiment of the present invention, in the step of reading in a second piece of object information, data may be read in from the second sensor, which is designed to detect objects which are situated outside a detection area of the first sensor, in particular which are situated ahead of a transportation means, in particular a vehicle, at a distance which is greater than a distance of a maximum limit of the detection area of the first sensor ahead of the transportation means. Such a specific embodiment of the present invention provides the advantage of a particularly advantageous selection of objects to be extracted, since the different ranges or detection distances of the sensors may be utilized in a particularly advantageous manner.

The method may include a step of determining a distance between an object represented in the filtered piece of object information and the transportation means, in particular the vehicle, in particular the distance being determined to that object which has the least distance from the transportation means. For example, the object may just no longer be detected by the first sensor. The distance may be a function of instantaneous visual conditions and/or visibility conditions of the object. For example, fog may degrade a visual condition. For example, a dark object may also have a poorer visibility condition than a light object.

A theoretical visual range of a driver of the transportation means may be determined, the visual range being determined to be less than the distance between the object and the transportation means. Thus, a distance which is greater than the visual range may be determined as the distance between the object and the vehicle. The distance may be greater than a theoretically possible visual range. The visual range may also be less than the distance by one safety factor. The object may be situated outside a real visual range of the driver. The real visual range may be less than the theoretical visual range.

The first sensor and the second sensor may be designed in order to provide the object information by evaluating signals from different wavelength ranges of electromagnetic waves. For example, in the step of reading in a first piece of object information, a piece of object information may be read in from the first sensor, and in the step of reading in a second piece of object information, a piece of object information may be read in from the second sensor, the first sensor providing measured values using signals in a first electromagnetic wavelength range, and the second sensor providing measured values by evaluating signals in a second electromagnetic wavelength range which differs from the first electromagnetic wavelength range. For example, the first sensor may receive and evaluate visible light and the second sensor may receive and evaluate infrared light. The second sensor may also, for example, transmit, receive, and evaluate radar waves. In the infrared spectrum, it is possible to resolve objects very well even under poor visual conditions, for example, in darkness. Radar waves are also able, for example, to pass through fog virtually unimpeded.

An infrared sensor may be designed as an active sensor which illuminates surroundings of the vehicle with infrared light, or may also be designed as a passive sensor which merely receives infrared radiation emitted by the objects. A radar sensor may be an active sensor which illuminates the objects actively using radar waves and receives reflected radar waves.

The method may include a step of displaying the filtered object data on a display device of the transportation means, in particular in order to highlight objects outside the visual range of the driver. In particular, the filtered object data may be displayed on a field of vision display. The filtered objects may be displayed in such a way that a position in the field of vision display matches a position of the objects in a field of view of the driver.

The instantaneous visual range of the driver and/or an instantaneous braking distance of the transportation means may be depicted according to another specific embodiment of the present invention. For this purpose, for example, the braking distance may be determined in a previous step, which is conditional upon a speed of the transportation means and possibly other parameters such as roadway wetness. Markings may be superimposed on the display device which represent the theoretical visual range and/or the instantaneous braking distance of the transportation means or vehicle. The driver may thus decide autonomously whether his/her driving is adapted to the instantaneous surrounding conditions, but advantageously receives technical information in order not to overestimate the driving behavior and/or the vehicle characteristics with respect to travel safety.

A maximum speed of the transportation means or vehicle which is adapted to the visual range may be depicted according to another specific embodiment. A maximum speed may be a target reference value for the speed of the transportation means. By displaying the maximum speed, the driver is able to recognize that he/she is driving at a different speed, for example, one which is too high. A difference in speed from the instantaneous speed of the transportation means or vehicle may be displayed. The difference may be highlighted in order to provide additional safety information to the driver.

According to another specific embodiment of the present invention, the maximum speed may be output as a setpoint value to a speed control system. A speed control system may adjust the speed of the transportation means or vehicle to the setpoint value via control commands. As a result, the transportation means or vehicle may, for example, lower the speed autonomously if the visual range decreases.

The method may include a step of activating a driver assistance system if the visual range of the driver is less than a safety value. For example, a reaction time of a braking assistant may be shortened in order to be able to brake more rapidly ahead of an object which suddenly becomes visible. Likewise, a field of vision display may, for example, be activated if the visual conditions become worse.

The present invention furthermore provides an information system for filtering object information which is designed to carry out or implement the steps of the method according to the present invention in corresponding devices. The object underlying the present invention may also be achieved rapidly and efficiently via this embodiment variant of the present invention in the form of an information system.

An information system may presently be understood to mean an electrical device which processes sensor signals and outputs control and/or data signals as a function thereof. The information system may include an interface which may have a hardware and/or software design. In a hardware design, the interfaces may, for example, be part of a so-called system ASIC which includes a wide variety of functions of the information system. However, it is also possible that the interfaces are self-contained integrated circuits or are made up at least partially of discrete components. In a software-based design, the interfaces may be software modules which, for example, are present on a microcontroller, in addition to other software modules.

According to another specific embodiment of the present invention, the method described above may also be used in a stationary system. For example, one or multiple fog droplets may thereby be identified as an “object,” whereby a specific embodiment designed in such a way may be used as a measuring device for measuring fog banks, in particular for detecting a density of the fog.

A computer program product including program code which may be stored on a machine-readable carrier such as a semiconductor memory, a hard-disk memory, or an optical memory, and which is used for carrying out the method according to one of the specific embodiments described above, is also advantageous if the program product is executed on a computer or a device.

The present invention is explained in greater detail below by way of example with the aid of the appended drawings.

### BACKGROUND OF THE INVENTION

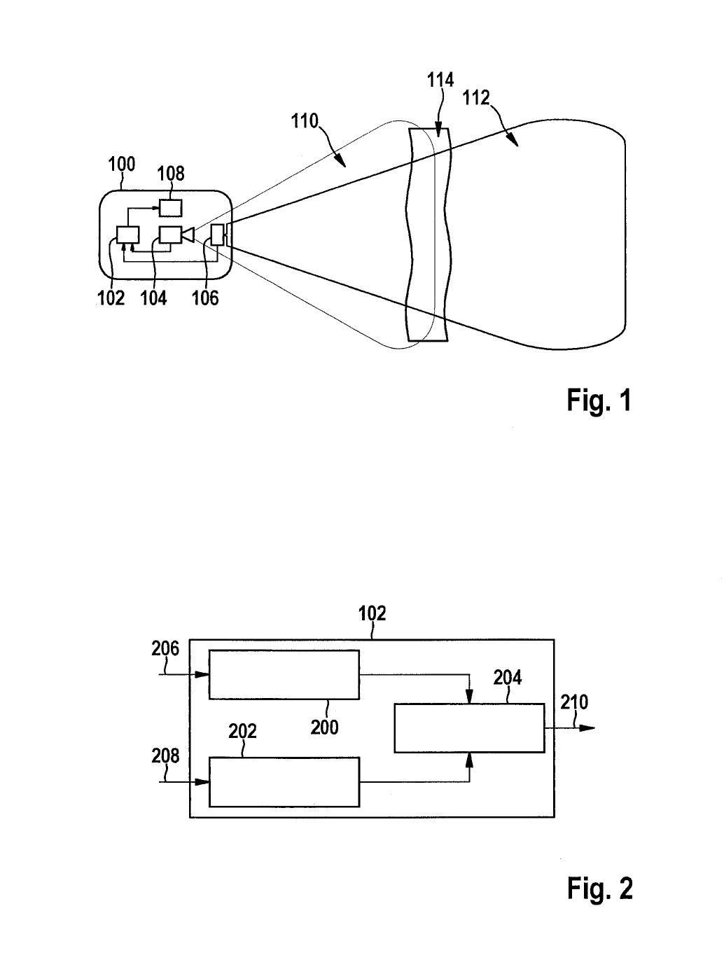

FIG. 1 shows a representation of a vehicle including an information system for filtering object information according to one exemplary embodiment of the present invention.

FIG. 2 shows a block diagram of an information system for filtering object information according to one exemplary embodiment of the present invention.

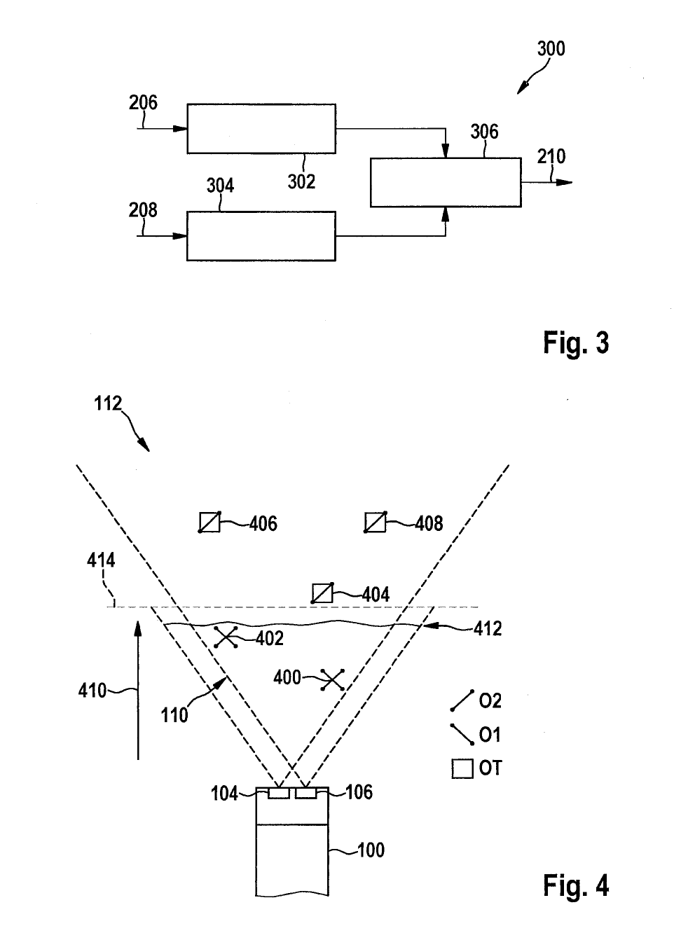

FIG. 3 shows a flow chart of a method for filtering object information according to one exemplary embodiment of the present invention.

FIG. 4 shows a representation of objects ahead of a vehicle which are filtered using a method for filtering object information according to one exemplary embodiment of the present invention.

### DETAILED DESCRIPTION OF THE INVENTION

In the following description of preferred exemplary embodiments of the present invention, identical or similar reference numerals are used for the elements depicted in the various figures and acting similarly; therefore, a description of these elements will not be repeated.

FIG. 1 shows a representation of a vehicle 100 including an information system 102 for filtering object information according to one exemplary embodiment of the present invention. Vehicle 100 includes a first sensor 104, a second sensor 106, and a display device 108. However, alternatively, a different transportation means such as a ship or an airplane may be equipped with corresponding units in order to implement one exemplary embodiment of the present invention. However, for reasons of clarity, the present invention is described in the present description based on one exemplary embodiment as a vehicle; however, this choice of the exemplary embodiment is not meant to be restrictive.

First sensor 104 is formed by a video camera 104 which scans a first detection area 110 ahead of vehicle 100. Video camera 104 detects images in the visible light spectrum. Second sensor 106 is designed as a radar sensor 106 which scans a second detection area 112 ahead of vehicle 100. Here, second detection area 112 is narrower than first detection area 110. Radar sensor 106 generates radar images by illuminating second detection area 112 with radar waves and receiving reflected waves or reflections from second detection area 112. First detection area 110 is smaller than second detection area 112, because a visual obstruction 114 (also referred to as a visibility limit), here, for example, a wall of fog 114, restricts first detection area 110. Wall of fog 114 absorbs a good portion of the visible light and scatters other components of the light, so that video camera 104 is not able to detect objects in wall of fog 114 or behind wall of fog 114. Video camera 104 is thus subject to the same optical limitations as the human eye. The electromagnetic waves of radar sensor 106 penetrate wall of fog 114 virtually unimpeded. As a result, second detection area 112 is theoretically restricted only by the radiated power of radar sensor 106. The images of camera 104 and of radar sensor 106 are handled or processed with the aid of an image processing unit which is not shown. Objects are detected in the images, and a first piece of object information which represents one or multiple objects in the camera image, and a second piece of object information which represents one or multiple objects in the radar image, are generated. The first piece of object information and the second piece of object information are filtered according to one exemplary embodiment of the present invention in filtering device 102 using a filtering method. Filtering device 102 outputs a filtered piece of object information to display device 108 in order to display objects in the display device which are concealed in or behind wall of fog 114. A driver of vehicle 100 is able to autonomously identify objects which are not concealed. These are not highlighted.

FIG. 2 shows a block diagram of an information system 102 for filtering object information for use in one exemplary embodiment of the present invention. Information system 102 corresponds to the information system from FIG. 1. The information system includes a first device 200 for reading in, a second device 202 for reading in, and a device 204 for outputting. First device 200 is designed to read in a first piece of object information 206. First piece of object information 206 represents at least one object detected and identified by a first sensor. The first sensor is based on a first sensor principle. Second device 202 for reading in is designed to read in a second piece of object information 208. Second piece of object information 208 represents at least two objects detected and identified by a second sensor. The second sensor is based on a second sensor principle. At least one of the objects is also represented in first piece of object information 206. The first sensor principle is different from the second sensor principle. Device 204 for outputting is designed to output a filtered piece of object information 210. Filtered piece of object information 210 represents those objects which are represented exclusively in second piece of object information 208.

In other words, FIG. 2 shows an information system 102 for measuring the visual range by combining sensors. For example, data of a surroundings sensor 104 from FIG. 1 in the visible light waveband (for example, mono/stereo video) may be combined with data of a surroundings sensor 106 from FIG. 1 outside the visible range (for example, radar, lidar). An object identification via a surroundings sensor system may provide a position and/or a speed and/or a size of the object as derived information. The piece of information may be provided on a human-machine interface (HMI) (for example, HUD) and may be optionally provided as networked communication via Car-to-X (C2X) and/or Car-to-Car (C2C) and/or Car-to-Infrastructure (C2I). The communication may be carried out in duplex mode.

FIG. 3 shows a flow chart of a method 300 for filtering object information according to one exemplary embodiment of the present invention. Method 300 includes a first step 302 of reading in, a second step 304 of reading in, and a step 306 of outputting. In first step 302 of reading in, a first piece of object information 206 is read in which represents at least one object detected and identified by a first sensor, the first sensor being based on a first sensor principle. In second step 304 of reading in, a second piece of object information 208 is read in which represents at least two objects detected and identified by a second sensor, the second sensor being based on a second sensor principle and at least one of the objects also being represented in first piece of object information 206, the first sensor principle differing from the second sensor principle. In step 306 of outputting, a filtered piece of object information 210 is output which represents those objects which are represented only in second piece of object information 208.

This additionally obtained information 210 may, for example, be used for optimizing HMI systems.

For example, no redundant information with respect to the lateral or longitudinal guidance (vehicle guidance) is depicted. This results in a reduction of the information overload of the driver and thus a lower load on the driver's cognitive resources. In critical situations, these freed cognitive resources contribute decisively to a reduction of the accident severity.

For example, a HUD (head-up display) may be used in a night-vision system, instead of the additional screen with the night-vision image of the surroundings. This HUD superimposes information 210 only if the driver is not able to identify it in the prevailing situation (fog, night, dust, smog, etc.).

The obtained information may, for example, be used when monitoring speed as a function of the visual range. The instantaneous maximum braking distance may be ascertained from the instantaneous vehicle speed. If this braking distance is below the value of the driver's visual range obtained by the system, a piece of information may be output via HMI based on the calculated values, which informs the driver of what his/her safe maximum speed is. Alternatively or in addition, the provided speed control system speed may be automatically adjusted using the safe maximum speed, for example, using an ACC or cruise control.

Obtained information 210 may also be used for adjusting an activation condition of driver assistance systems (DAS). Today, semiautonomous assistance systems still require an activation by the driver. However, if the driver is not yet aware of the hazard because he/she cannot identify it, the DAS is activated too late. With the aid of the driver's visual range ascertained according to the approach described here, the activation conditions may be modified in order to take into account the surrounding situation and if necessary, to take necessary precautions in order to nevertheless minimize an accident.

FIG. 4 shows a representation of objects ahead of a vehicle 100 which are filtered using a method for filtering object information according to one exemplary embodiment of the present invention. The method for filtering corresponds to the method as shown in FIG. 3. Vehicle 100 corresponds to a vehicle as shown in FIG. 1. First sensor 104 and second sensor 106 are situated on a front side of vehicle 100.

However, in another exemplary embodiment which is not shown here, second sensor 106 may also be situated on a side of the vehicle other than the front side. Unlike FIG. 1, sensors 104, 106 each have a similar detection angle. First sensor 104 has first detection area 110. In first detection area 110, first set of objects O1 is detected, which is made up here of two objects 400, 402. First set of objects O1 is indicated by a bar slanting from the upper left to the lower right. Second sensor 106 has second detection area 112. In second detection area 112, second set of objects O2 is detected, which is made up here of five objects 400, 402, 404, 406, 408. Second set of objects O2 is indicated by a bar slanting from the upper right to the lower left. Detection areas 110, 112 overlap. An intersection O1∩O2 of the two objects 400, 402 here is detected by the two sensors 104, 106. Intersection O1∩O2 is indicated by slanting crossed bars. A difference set O2\O1 of the three objects 404, 406, 408 here is detected exclusively by second sensor 106. Difference set O2\O1 is set of objects OT and is indicated by a square frame. Due to a visual obstruction, detection area 110 of first sensor 104 has a fuzzy limitation 412 facing away from the vehicle. Due to the visual obstruction, a driver of vehicle 100 has a similarly limited visual range 410. Object 402 may barely be perceived by the driver. Object 402 may barely be detected by sensor 104 since the front limitation is farther way from vehicle 100 than object 402. From among the objects in set of objects OT, object 404 is situated closest to vehicle 100. A distance from object 404 is determined and is used as a theoretical visual range 414. Actual visual range 410 and theoretical visual range 414 do not correspond directly, but are similar. Theoretical visual range 414 is greater than actual visual range 410. Actual visual range 410 may be estimated using a safety factor. The driver is not able to see objects 404, 406, 408 of set of objects OT. Therefore, objects 404, 406, 408 may advantageously be displayed on the display device of vehicle 100, for example, a head-up display. The driver may thus obtain important information which he/she would otherwise not receive. In order not to overload the driver, objects 400, 402 of set of objects O1 are not depicted.

In summary, it may be noted that surroundings sensor system 104 which operates in the visible light range is subject to the same visibility conditions as the driver. Using object detection, objects 400, 402 which lie in the visual range of the driver may thus be identified. This results in set of objects O1. If object detection takes place using data which lie outside the visible range for humans, objects may be observed regardless of the (human) visibility conditions.

Objects 400 through 408 which are detected in this way form set of objects O2 here.

According to the approach described here, a symbiosis of the data and a mapping of the objects in set O1 to set O2 takes place. Such objects 404 through 408 which are present in set O2 but which have no representation in O1 form set of objects OT. This thus constitutes all objects 404 through 408 which are not detected by video sensor 104. Since video sensor 104 and humans are approximately able to cover or sense the same range of the light wave spectrum, objects OT are thus also not apparent to the driver.

Object OTₘᵢₙ 404 of set OT, which has the least distance 414 from host vehicle 100, may thus approximately be considered to be the theoretical maximum visual range of the driver, even if this is correct only to a certain extent.

The exemplary embodiments described and shown in the figures are selected only by way of example. Different exemplary embodiments may be combined completely or with respect to individual features. One exemplary embodiment may also be supplemented by features of an additional exemplary embodiment.

Method steps according to the present invention may furthermore be repeated and executed in a sequence other than the one described.

If an exemplary embodiment includes an “and/or” link between a first feature and a second feature, this is to be read as meaning that the exemplary embodiment according to one specific embodiment has both the first feature and the second feature and has either only the first feature or only the second feature according to an additional specific embodiment.

1-12. (canceled)

13. A method for filtering object information, comprising:
reading in a first piece of object information which represents at least one object detected and identified by a first sensor, the first sensor being based on a first sensor principle;
reading in a second piece of object information which represents at least two objects detected and identified by a second sensor, the second sensor being based on a second sensor principle differing from the first sensor principle, wherein at least one of the two objects is also represented in the first piece of object information; and
outputting a filtered piece of object information which represents objects which are represented only in the second piece of object information and not in the first piece of object information.

14. The method as recited in claim 13, wherein in the step of reading in the second piece of object information, data are read in from the second sensor, which is configured to detect objects which are situated outside a detection area of the first sensor.

15. The method as recited in claim 14, further comprising:
determining a distance between an object represented in the filtered piece of object information and a vehicle having the first and second sensors, wherein the distance is determined from the object which has the least distance from the vehicle.

16. The method as recited in claim 15, wherein in the step of determining, a visual range of a driver of the vehicle is furthermore determined, and wherein a distance which is greater than the visual range is determined as the distance between the object and the vehicle.

17. The method as recited in claim 14, wherein in the step of reading in a first piece of object information, a piece of object information is read in from the first sensor, and in the step of reading in a second piece of object information, a piece of object information is read in from the second sensor, the first sensor providing measured values using signals in a first electromagnetic wavelength range and the second sensor providing measured values by evaluating signals in a second electromagnetic wavelength range which differs from the first electromagnetic wavelength range.

18. The method as recited in claim 14, further comprising:
displaying the filtered object data on a display device of the vehicle in order to depict objects which are outside the visual range of the driver.

19. The method as recited in claim 18, wherein in the step of displaying, at least one of an instantaneous visual range of the driver and an instantaneous braking distance of the vehicle is depicted.

20. The method as recited in claim 18, wherein in the step of displaying, a maximum speed of the vehicle which is adapted to the visual range of the driver is depicted.

21. The method as recited in claim 20, wherein in the step of outputting, the maximum speed of the vehicle which is adapted to the visual range of the driver is output as a setpoint value to a speed control system.

22. The method as recited in claim 21, further comprising:
activating a driver assistance system of the vehicle if the visual range of the driver is less than a predefined safety value.

23. A non-transitory, computer-readable data storage medium storing a computer program having program codes which, when executed on a computer, perform a method for filtering object information, comprising:
reading in a first piece of object information which represents at least one object detected and identified by a first sensor, the first sensor being based on a first sensor principle;
reading in a second piece of object information which represents at least two objects detected and identified by a second sensor, the second sensor being based on a second sensor principle differing from the first sensor principle, wherein at least one of the two objects is also represented in the first piece of object information; and
outputting a filtered piece of object information which represents objects which are represented only in the second piece of object information and not in the first piece of object information.
